(19) United States
(12) Patent Application Publication
(10) Pub. No.: US 2001/0041208 A1
(43) Pub. Date: Nov. 15, 2001

(54) Stabilization process for combining ethyl alcohol and ice cream

(75) Inventors: Daryl J. Orris, Minneapolis, MN (US); Rulon Chappell, North St. Paul, MN (US)

Correspondence Address: MARK A. LITMAN & ASSOCIATES, P.A., York Business Center, 3209 W. 76th St., Suite 205, Edina, MN, 55402, US

(73) Assignee: Ice Cream Bar, Inc.

(21) Appl. No.: 09/850,153

(22) Filed: May 8, 2001

Related U.S. Application Data
(63) Continuation-in-part of application No. 08/242,642, filed on May 13, 1994, now abandoned.
Application No. 08/242,642 is a continuation-in-part of application No. 08/927,580, filed on Sep. 8, 1997, now abandoned.

(51) Int. Cl. A23G 9/02

(52) U.S. Cl. 426/573; 426/565

(57) ABSTRACT

A stabilization process produces an ice cream type product containing alcohol greater than ½ of 1% by volume wherein a stabilizing blend is added into the product allowing the possibility of mixing ethyl alcohol and/or ethyl alcohol based flavoring systems with ice cream mix, prior to freezing, to produce an ethyl alcohol based frozen ice cream type product wherein the ethyl alcohol and/or ethyl alcohol based flavoring system(s) become(s) a homogeneous part of the whole which does not separate, break down or melt the product. In addition, the ice cream type product may be maintained in a solid state without such melting, denaturing or breakdown for as much as one year or longer and, even if refrozen after partial thawing, there is little adverse effect on the preferred taste or texture profiles.

### CROSS REFERENCES TO RELATED APPLICATIONS

This invention is a continuation-in-part of abandoned U.S. patent application Ser. No. 08/242,642, filed May 13, 1994, which is also a continuation-in-part of U.S. patent application Ser. No. 08/927,580, filed Sep. 8, 1997.

### BACKGROUND

1. Field of the Invention

The invention relates to ice cream type products, to the manufacture of an alcoholic ice cream type product, and to the stabilization of an ice cream mix in frozen or semi-soft form in the presence of alcohol or flavored alcohol.

2. Background of the Art

The mixture of ice cream and flavored alcohol to form ice cream drinks was popularized in the United States in the early 1900's. At that time, bartenders determined that certain combinations of flavored alcohol and fresh dairy cream had unique and desirable taste profiles that caused people to desire to consume them. After the second world war, ice cream was sometimes exchanged for dairy cream in consumer products.

Old Mr. Boston, Deluxe Official Bartender's Guide (Cotton) published 1963, by Mr. Boston Distiller Inc. lists various preferred flavored alcohols that, when added to frozen ice cream, produced desired taste profiles. These “ice cream drinks” can be made in liquid form or made to temporarily retain a semi-frozen or soft form. However, Cotton's “Ice Cream Drinks” are described as bartender prepared beverages which are available only for immediate consumption.

Cotton's ice cream drinks, like all other ice cream and alcohol beverages heretofore conceived, have not been able to be stored in frozen form without undergoing separation between components. For example, when an alcohol or a flavored alcohol composition is frozen in ice cream, the alcohol molecules interact in the mixture with ice crystal and/or the milk protein in ice cream and in a matter of minutes, an undesirable separation of the drink components begins to occur. Furthermore, when such an “ice cream drink” is thawed and refrozen, undesirable texture changes occur, such as the creation of larger ice crystals and caverns or porous areas.

Cotton's formulas are mixed for immediate or nearly immediate consumption. Cotton's formulas do not contemplate or enable a product capable of long term storage of a frozen or near-frozen alcohol/ice cream composition. Cotton's formulas do not even mention freezing a mixture of alcohol with ice cream. Cotton also does not consider commercial production of large volumes of single flavors which must be stored for extended time periods.

Another source of information in the background of the art is the description of ice cream making by Robert T. Marshall, Arbuckle's Ice Cream, Fifth Edition, Chapman & Hall (1996). The disclosure in this publication is merely of ice cream recipes. There is no mention of the presence of alcohol in proportions of greater than 0.05% by volume in any of the formulas. The recipes give no indication of a method to make, much less store, a stable, homogeneous composition consisting of ice cream and alcohol or flavored alcohol(s) in proportions of greater than 0.05% by volume, in a frozen condition, for long periods of time, without separation of the ingredients.

U.S. Pat. No. 5,019,414 is where Valdes discloses a pipeable or spreadable gel which comprises a gelled or non-beverage form of an alcohol containing product. Valdes' product is a non-liquid, clear, pipeable gel. Theoretically, this pipeable gel can be added to frozen desserts, such as ice cream, sherbets and the like, after the freezing process, without melting them. The alcohol containing gel is rippled, folded, piped or ribboned in a nonhomogeneous manner into a frozen product or added as a topping. This method of application of the ribbon of the gel tends to inhibit the antifreeze action (or melting activity) of the alcohol component, so long as the gel has been incorporated into the dessert after the dessert has been frozen and the gel is maintained as a distinct phase, rather then a component of a homogeneous mixture.

Unfortunately, the alcoholic gel must retain its phase identity distinct from the body of the ice cream. Furthermore, this gel is incorporated into the ice cream after the ice cream has been made and frozen. If added to ice cream, Valdes' pipeable gel and the alcohol contained therein could be removed mechanically from the ice cream by a person with a tool such as a spoon. The gel is in a distinct phase with, but separate from, the ice cream composition. The gel mixture does not create a homogeneous chemical composition or system containing alcohol indistinguishable and mechanically inseparable from the body of the food (the ice cream). This prevents the Valdes gel from being used to create frozen type “ice cream drinks,” containing alcohol, as made in America's bars and restaurants. The public's preferred taste profiles for ice cream alcohol drinks cannot therefore be addressed via the Valdes gel. Thus, for example, the invention cannot be used to produce a traditional grasshopper.

Also, a further problem with Valdes invention could reduce its ability to be used commercially in the United States. United States law classifies products with more than ½ of 1% alcohol by volume, not as food, but as various different alcohol types of products which are strictly regulated by the Bureau of Alcohol, Tobacco and Firearms (ATF). The Code of Federal Regulations, Title 27, further requires that the alcohol content of such products must be stated on the package to an accuracy of ¼ of 1% by volume. The theoretic piping or ribbing type technique of Valdes, because the ribbon cannot be distributed uniformly or consistently, would not facilitate the manufacture of a product so that its alcohol content could be stated with certainty within the statutorily required ¼ of 1% by volume. Thus, the law operates to make the Valdes technique commercially impractical and/or impossible.

Furthermore, Valdes' alcohol gel retains its identity distinct from the body of the ice cream. This could enable abuse of the product by removal of the ribbons with their higher alcohol content and their use as a high alcohol content product. Furthermore, this gel is incorporated into the ice cream after the ice cream has been made and frozen. It would be important to the field to devise an alcohol/ice cream product that does not suffer from some or all of these disadvantages.

### SUMMARY OF THE INVENTION

The present invention relates to a useful, novel and unexpected advancement in the art of making alcoholic ice cream, distilled spirit-ice cream and/or alcoholic frozen ice cream type drinks. This is accomplished by providing a novel stabilizing component and/or combination of stabilizing compounds in an ice cream mix and by the new and different process of making the ice cream type product (i.e. adding chilled ethyl alcohol components). The stabilizing element does not contain the alcohol, and the final composition and product can be a homogeneous composition in which the ice cream component, the alcohol component, and the stabilizer component cannot be individually removed by mechanical separation techniques such as filtration, scooping, or cutting.

The invention allows for the addition of alcohol flavoring systems, in liquid form, prior to any freezing. The alcohol component is not added as a distinct phase stable component (not in a gelled form, such as a topping or ribbon), and is not added after the ice cream has been completely frozen. These liquid alcohols become a part of a homogeneous mixture, suspension, dispersion or even solution with the other components of the product.

### DETAILED DESCRIPTION OF THE INVENTION

The invention includes the compositions of ice cream type products and methods of manufacturing ice cream type products comprising dairy product solids and alcohol or flavored alcohol components. The typical dairy product solids may include milk solids, cream solids, whey, cream by-products and milk by-products. The practice of the composition is best performed with a high solids content ice cream mix as the base. It is believed that the high dairy product solids content of the mix allows for the additional liquids from the alcohol flavoring systems to be accommodated in the product, and most importantly, stabilize the mix against separation and property changes. The dairy product solids tend to withdraw available liquids in the mix (i.e. water) and to allow for the additional liquids of the flavoring systems to be partially absorbed or otherwise stabilized into the dairy product solids. The combined effect of high solids ice cream, the dairy product solids and stabilizer (particularly a preferred set of stabilizers) allows the creation of a homogeneous frozen ice cream or ice cream type product containing alcohol and/or a homogeneous frozen ice cream or ice cream type product containing alcohol with an approximately soft-serve consistency, either of which can be stabilized and stored frozen on a long term basis. (Long term would be at least three months, preferably at least six months and more preferably one to two years without obvious undesirable changes in the product such as shrinkage, component separation, texture changes or taste changes.)

In addition a preferred aspect of the invention is blending the flavored alcohol, in quantity, while chilled to partially frozen (for example, about 0 to 30 degrees Fahrenheit or 5 to 30 degrees F., or about 15-30 degrees F.). These chilled to partially frozen mixes are stable against separation, where other attempts to provide mixes have to be used immediately because of instability. This concept is one of many in the practice of the present invention which does not appear in the teachings of the prior art with respect to the manufacture of ice cream type products with an alcohol component. Such a limitation, for example, is not present or mentioned in the Cotton reference. Valdes does not describe any limitation on temperature ranges. Valdez, in fact, shows the use of highly elevated temperatures to be a necessity in the use of carrageenan in his composition (which can be added to ice cream to form a mixture). Arbuckle's Ice Cream does not address or teach the addition of alcohol to ice cream to form single flavoring systems of more than 0.05% by volume alcohol. Therefore, the use of the greatly reduced temperatures in the combination of alcohol component elements in the manufacture of these types of products is not only absent from the teachings of the references, it tends to go against the teaching of the use of higher temperature control in the provision of stabilization ingredients which is present in the references. Additionally, the chilled products of the invention are stabilized against separation and other adverse effects of the combination of the ice cream solids and the alcohol. Although not wishing to be restricted to a single interpretation of the cause of the benefits, it is hypothesized that the larger amounts of solids used in the present invention tend to absorb or otherwise stabilize the extra liquid of the distilled spirits (the alcoholic beverage), making it possible to use real liquor and liqueurs for the flavoring system.

Arbuckle 's Ice Cream deals with ice cream, which is classified as a food product by United States law and regulated by the FDA. When this invention or any other method is used to create a product with greater than ½ of 1% alcohol by volume, the method creates an alcoholic beverage or ice cream type product in solid form, rather than a food product. The ATF and FDA have jointly agreed, in writing, that this general type of product is an alcoholic beverage and not a food product like ice cream. Alcoholic beverages are regulated by the ATF. Marshall and Arbuckle 's ice cream is regulated by the FDA.

Accordingly, besides the general aspects and advantages above described, several features and advantages of this invention are:

a) to provide a stabilizing ice cream mix blend comprised of dairy product solids, non-thermoreversible gums such as mannan gums, e.g., locust bean gum, digestible thickening gums (such as a cellulosic gum and lower molecular weight and digestible or inert natural or synthetic resins, extenders and gums) and thermoreversible gums such as carrageenan (e.g., kappa, iota, and lambda carrageenan) whereby when said stabilizing ice cream mix blend is combined with a basic ice cream mix and subsequently with ethyl alcohol and then frozen, the ethyl alcohol molecule is stabilized in an ice cream like product so that after said freezing, the ethyl alcohol does not change the form, texture or homogeneity of the ice cream like product in an adverse manner.

b) to provide a method whereby alcohol can be admixed with an ice cream type product or ice cream type mix to make a homogeneous alcoholic product which is then frozen, provided in a solid state, and the frozen alcoholic ice cream type product can then be stored indefinitely (as herein defined) without appreciable decomposition;

c) to provide a method whereby alcohol can be admixed with an ice cream type product or ice cream type mix to make a homogeneous frozen alcoholic product in a soft-serve or semi-soft consistency which can then be stored indefinitely (as defined herein);

d) to provide a method whereby alcohol flavoring systems, containing taste profiles preferred by the public can be admixed with ice cream in a manufacturing or compounding process to make a homogeneous, hard frozen alcoholic ice cream type product or mix (hereinafter collectively referred to as an “alcoholic ice cream”) or a homogeneous frozen alcohol drink in a soft-serve or semi-soft consistency, which can be stored indefinitely (as defined herein);

e) to provide a hard frozen alcoholic ice cream or a soft-serve or semi-soft serve alcohol drink with a consistent flavor;

f) to provide a hard frozen alcoholic ice cream or a soft-serve or semi-soft serve alcohol drink with a consistent texture;

g) to provide a hard frozen alcoholic ice cream or frozen alcohol drink in a soft-serve or semi-soft consistency in a convenient, premade form for later consumption;

h) to provide a hard frozen alcoholic ice cream or a soft-serve or semi-soft alcoholic drink as an ingredient which can be spread onto, into or otherwise provided as a part of other foodstuffs such a pie filling, food topping or floating component on a liquid, for later consumption;

I) to provide a hard frozen alcoholic ice cream which could be presented for consumption adhering to or served on other matter, such as around a stick, on a cone, in a cup, within a cake, or other manners in which ice cream may be presented;

j) to provide a hard frozen alcoholic ice cream or a soft-serve or semi-soft frozen alcohol drink which can be made in one locale and stored for shipping to and consumption at a far distant locale;

k) to provide a hard frozen alcoholic ice cream or soft-serve or semi-soft frozen alcohol drink which, due to storage capability, can be manufactured economically in mass quantities at one locale for distribution at diverse and distant locales;

l) to provide a hard frozen alcoholic ice cream-type distilled spirit product or soft-serve or semi-soft frozen alcohol drink which, due to storage capability, can be packaged with tamper resistant closures;

m) to provide a hard frozen alcoholic ice cream or soft-serve or semi-soft frozen alcohol drink which, due to storage and manufacturing capability, is made and can be repeatedly made with a consistent, known and labeled proof and/or alcoholic content;

n) to provide a hard frozen alcoholic ice cream or soft-serve or semi-soft frozen alcohol drink which may be used as a beverage mix and can save time for the bartender and/or consumer;

o) to provide a hard frozen alcoholic ice cream or soft-serve or semi-soft frozen alcoholic drink which, due to storage capability, can be manufactured in known or ascertainable sanitary conditions;

p) to provide a hard frozen alcoholic ice cream or soft-serve or semi-soft frozen alcohol drink which, due to labeling requirements, contains accurate label information allowing the consumer to determine the content (including the alcohol content within ¼ of 1% by volume) of the product consumed;

q) to provide a hard frozen alcoholic ice cream or soft-serve or semi-soft frozen alcohol drink which can conveniently and economically be provided in a variety of taste profiles;

r) to provide a hard frozen alcoholic ice cream soft-serve or semi-soft frozen alcohol drink which can be provided conveniently in a variety of quantities, such as in packages which would make advertising more convenient;

s) to provide a hard frozen alcoholic ice cream or soft-serve or semi-soft frozen alcohol drink which is simply, conveniently and/or quickly prepared and/or used;

t) to provide a means by which declining industry distilled spirits sales can be renewed and increased and to provide new customers to liquor retailers;

u) to provide a means for a new use of dairy butter fat, to renew and increase dairy production; and

v) to provide a new beverage alcohol technology and new ice cream technology.

Carrageenan is a natural hydrocolloid, a polysaccharide hydrocolloid, which is derived from seaweed. It comprises a carbohydrate polymer of repeating sugar units, which is linear, without significant numbers of branches or substitutions. Most, if not all, of the galactose units on a Carrageenan molecule possess a sulfate ester group. The exact position of the sulfate groups, the cations on the sulfate groups, and the possible presence of an anhydrous bridge on the molecule differentiates the various types of Carrageenan. There are basically three distinct types of Carrageenan which each behave differently and have distinct properties and differences. These are the kappa, iota and lambda forms of Carrageenan, although there are also minor fractions of mu and nu Carrageenan forms. These various forms can significantly vary in properties, as exemplified by the fact that lambda Carrageenan in solution is unable to associate into a structure, so that it cannot gel, but may act as a thickener. Both kappa and iota Carrageenan are able to gel. Kappa Carrageenan is known to form gels in the presence of potassium cations. These gels tend to be brittle and exhibit syneresis (contraction and release of entrapped liquid) as the gel shrinks. Iota Carrageenan tends to react strongly to calcium cations and forms a more tender, flexible gel than kappa Carrageenan that is not as susceptible to syneresis. κ-Carrageenan when dissolved in water by heating, followed by cooling, can form thermoreversible gels, optionally in the presence of additionally added cations. A film-forming gel mass is prepared by combining κ-carrageenan, water (preferably deionized water), an optional gelling salt(s), and plasticizer. Gelling salts can be salts of divalent cations such as calcium, magnesium, and barium or salts of monovalent cations such as potassium and sodium. Preferably, where a gelling salt is additionally used (in addition to the salts which may be naturally present in the commercial κ-carrageenan), a salt comprising a potassium salt, and in particular, a highly soluble potassium halide such as potassium chloride, is used. Carbohydrates, especially liquid carbohydrates or cellulosic gums, whether natural or synthetic, such as glycerin, alkylene glycols (e.g., polyethylene glycol, propylene glycol, and their mixtures or functionalized derivatives, the number present after the Tradename usually relating approximately to the molecular weight or the number of repeating units of the glycol), sorbitol (and sorbitol solution), maltitol, lactitol, xylitol, corn syrup solids, and other polyols or combinations of the above can be used as plasticizers or another desired additive. Preferably, cellulose resins which are digestible may be used. Cellulosic resins include materials comprising high fiber or microfiber content which bonds into a film or gel structure by chemical and/or physical reaction between chemical groups on the molecules (including polymeric molecules) in the cellulosic material. By digestible it does not mean that nutritional value is obtained from the resin, but that it can pass through the digestive track of a person without adverse effects and possibly contribute fiber to the diet. As a plasticizer for the gums and resins, a mixture of maltitol syrup and sorbitol solution may be used.

It is desirable to be able to distinguish amongst the various types of gums preferred and tolerated in the practice of the present invention. Gums (hydrocolloids) that form thermoreversible gels or contribute to the formation of thermoreversible gels include, for example, κ-carrageenan, iota-carrageenan, xanthan gum, gellan gum, and mannan gums (such as locust bean gum, konjac gum, tara gum, guar and cassia gum). The specific words used in the description of “or contribute to the formation of thermoreversible gels” are important because some of these gums, such as the mannan gums and xanthan gum, do not form thermoreversible gels by themselves, but they form thermoreversible gels with carrageenan through a synergistic effect. Gums (hydrocolloids) that do not form thermoreversible gels include dextrins (including maltodextrin), proteins, gum arabic and polyvinylpyrrolidone (e.g., Povidone™). The latter gums may simply be film formers (such as gum arabic and Povidone™) or both film formers and formers of non-thermoreversible (heat stable) gels (such as various plant proteins, for example, soy protein). The term ‘thermoreversible gum’ therefore refers to a gum the gel of which is thermoreversible or contributes to the formation of thermoreversible gels with κ-carrageenan.

Optionally, mannan gums (e.g., locust bean gum, konjac gum, guar, and tara gum) which have a synergistic gelling effect with κ-carrageenan can be added to increase gel strength and elasticity. Also, part of κ-carrageenan may be substituted by iota-carrageenan (preferably up to a maximum of 50% or 25% by weight of the κ-carrageenan) which forms “softer” and more elastic gels. Mechanical properties of carrageenan films can also be improved through a synergistic effect with added mixtures of xanthan gum (a microbial gum) and mannan gums such as locust bean gum or gellan gum or other materials which contribute to the formation of thermoreversible gels.

Optionally, hydrolyzed starches, such as maltodextrin (a hydrolyzed starch and an inexpensive biopolymer), are added to 1) increase solids concentration in the gel mass, and 2) prevent “hazing” of dried carrageenan capsules induced by the gelling salt and, if added, the mannan gums. Maltodextrin from corn starch is optionally used due to wide availability and low cost. However, dextrins from other starchy feedstocks (e.g., wheat, rice, barley, tapioca, potato, and cassava) can be used as well.

Optionally, a native or modified water-soluble or water-dispersible protein (or mixtures of proteins) derived from plant sources including, but not limited to, cereals (e.g., wheat, corn, sorghum, rice, and oat), oilseeds (soybeans, peanuts, and cottonseed), tubers (e.g., potato), and legumes (e.g., pea and lentil) is incorporated in the gel mass to increase wet tackiness, thus improving binding properties of the mass. Of course, animal proteins (e.g., whey protein, keratin, casein, egg albumen, and fish myofibrillar protein) may be used for this purpose as well.

Still further aspects and advantages will become apparent from a consideration of the ensuing description and flow chart.

### DESCRIPTION OF PREFERRED EMBODIMENT

A step which may be preliminary to creating a frozen product of this invention is the making of a stabilizer blend and a basic ice cream mix which are subsequently blended together to form a basic stabilized or stabilizing ice cream mix. Said basic stabilizing ice cream mix is in turn further processed by the admixture of a particular type of ingredient comprising ethyl alcohol or a flavored ethyl alcohol.

The first step in this process is therefore the creation of a stabilizing ice cream mix. It is emphasized that this particular stabilizing mix is a departure from the customary or known making of ice cream mix because the stabilizing mix is specifically designed to absorb or accommodate (1) liquid from the ice cream mix and (2) the admixture of liquors and/or liqueurs therein without adverse effect from long term storage. This may be enhanced by a combination of or selection from amongst:

1. Storing the mix after pasteurization, homogenization, and cooling anywhere from one day to a few days. This allows time to accommodate the hydration of the milk proteins. Hydration helps facilitate the future admixture of liquors and/or liqueurs.

2. A stabilizing mix which is designed to accommodate extra liquid from the liquors and/or liqueurs. This effect is accomplished by the creation of a unique stabilizer blend which constitutes a range of about 0.05% to about 1.5% of the entire basic stabilizing ice cream mix. While other ice creams may utilize all or most of the components in the stabilizer, for the first time a high percentage of milk and whey solids is being used with the non-thermoreversible gum, such as locust bean gum), digestible gum (e.g., cellulose gum) and thermoreversible gum (such as carrageenan). The stabilizer blend consists of:

a) dairy product solids (milk and whey solids) 5-20%, e.g., 10%

b) stabilizer gum (e.g., locust bean gum) 20-60%, e.g., 40%

c) digestible gum (e.g., cellulose gum) 20-60%, e.g., 40%

d) thickening gum (e.g., carrageenan) 5-20%, e.g., 10%

100%

In this process the carrageenan does not function as a normal gum or even just a thickening gum. Carrageenan and its herein stated equivalents may interact with the casein to prevent the separation of proteins which have been denatured by the alcohol. This explanation is gratuitously offered while not being bound by this theory.

The stabilizer blend is a new and novel composition for ice cream-type products or mixes. It is at least in part the heretofore unknown additional ingredients and proportions of ingredients in the formula for the ice cream-type product or mix that reduces the formation of or prevents the problems previously identified, such as large ice crystal formation, usually formed in the freezer. The stabilizer blend prevents the ice cream from being separated into or reduced to a liquid state when alcohol and/or alcohol flavoring systems are present.

3. A basic stabilizing ice cream mix designed with a lowered sugar content to accommodate the future extra sugar from the liquors and/or liqueurs.

4. Chilled (about 0-30 degrees F., 5 to 30 degrees F.—or otherwise below about 30 degrees F.) liquors and/or liqueurs which are added to the mix just prior to freezing. This pre cooling or prefreezing addition of chilled liquors and/or liqueurs reduces stress to the product and allows the proper formation of ice crystals (natural to ice cream) in the freezer. (The process also will work if room temperature liquors and/or liqueurs are added but it causes stress to the product [e.g., some loss of preferred taste and texture profile] because of a longer freezing time in the barrel and less than desired overrun targets. Furthermore, the extended agitation that room temperature liquor and/or liqueur additions require disrupts the ice cream stabilizer and the taste profile.)

A process for practice of the present invention may include the following steps, the process beginning with the creation of a stabilizing blend and ends with storage of a stable, homogenous, ice cream type product with ethyl alcohol in it and may be practiced by:

1. Creation of Stabilizer Blend

Mix a stabilizer blend comprising:

a) dairy product solids (milk and whey solids) 10% e.g., 5-20%

(E.g., VersaPro™ by Davisco Foods International, Inc.)

b) a non-thermoreversible gum, such as locust bean gum 40% e.g., 20-60%

c) cellulose gum or its equivalent 40% e.g., 20-60%

d) thermoreversible gum such as carrageenan 10% e.g., 5-20%

2. Mixture of the Basic Stabilizing Ice Cream Mix

Mix the ingredients of the stabilizer blend with the basic ice cream mix (any commercial manufacturing formulation will be adequate) to form a basic stabilizing ice cream mix so that the new mix contains the following:

Percentage of total mix

I. milk (3.2% fat content preferred) 46.57% e.g., 25-65%

ii. cream (40% fat content preferred) 33.77% e.g., 20-55%

iii. Non-fat dry milk 4.21% e.g., 2-11%

iv. Sweetener, e.g., Sugar (granulated) 15.00% (sugar) e.g., 4-25%,

1-10% art.swtnr.

v. Flavoring, e.g., Vanilla extract (if desired) 0.15% 0 or 0.05 to 5%

vi. Stabilizer blend (content indicated above) 0.30%, e.g., 0.05 to 3%

The ingredients may be mixed so that a normal commercial quantity for a batch efficient for the plant size is created by using the proportions indicated above. (The future admixture of liquors and/or liqueurs will increase the final volume. Final volume will also be increased approximately 50% to 100% through the introduction of air in the freezing process.)

3. Pasteurization

The entire quantity of ingredients, having been thoroughly mixed is preferably then pasteurized. In the preferred embodiment the mixture is pasteurized at above 160° F., e.g., at about 175 degrees F. for 20-30 seconds, e.g., 25 seconds. (Any legal pasteurization process could be utilized. This happens to be the preferred process).

Liquors and liqueurs are not pasteurized because the presence of ethyl alcohol places them in a relatively sterile state and the added heat would evaporate part of the alcohol.

4. Homogenization

Homogenization of the mixture is preferred and accomplished by any normal homogenization process, such as: the mix is placed under a first stage of pressure of over 1000 PSI, such as 2,000 P.S.I. to the point that a temperature above 150° F. of 165° F. is reached. It is then placed under a second stage of pressure of 500 P.S.I. for as long as the mixture remains at 165° F. The pasteurization and homogenization can be accomplished using either a batch or continuous process. The continuous process is preferred. The pasteurization can occur before or after the homogenization. High temperature, fast pasteurization usually requires at least 175 degrees F. for at least 25 seconds, while vat pasteurization usually requires at least 155 degrees F. for thirty (30) minutes.

Again, liquors and liqueurs are not homogenized, because the presence of ethyl alcohol places them in a sterile state and the heat would cause some of the alcohol to evaporate. Also, the ethyl alcohol flavoring systems are homogeneous already.

5. Cooling and Mix Storage

After homogenization, the mixture is cooled and stored until it is added to the mix tank. Cooling should be to less than about 40 degree F. Storage time should be from a minimum of one to a few days. This storage will allow the composition to accommodate and allow hydration of the milk proteins. This hydration will help accommodate the future introduction of the flavoring systems (liquors and/or liqueurs). The above mixture of ingredients results in a cooled basic stabilizing ice cream mix, which in its preferred embodiment, has 14.40% fat w/w (e.g., between 10 and 20% fat w/w), 40.5% total solids w/w (e.g., 30-50% total solids w/w) and a specific gravity between about 1.1 and 1.2 such as 1.147 (calculated).

6. Addition of Liquid Flavorings including Liquors and/or Liqueurs

Just prior to freezing, the mix is pumped into a mix tank where the proper amount of preferably chilled (0-30 degrees F.—e.g., 20 degrees F.) liquors and/or liqueurs and other flavoring ingredients are added and blended into the mix. The addition of chilled (but not completely frozen) liquids is preferred to reduce stress on the product and to assist in the formation of ice crystals. Desired coloring and/or other liquid ingredients may also added at this stage.

7. Freezing of Mix

Immediately after the addition and full blending of the flavoring systems, the resultant mix is frozen. The mix is then pumped into the ice cream freezer (either a batch or continuous process). Air is incorporated into the admixture so that the product is 150% of the initial volume and such that a 100-ml. container's portion target weight is approximately 72 grams. (If desired, it would be possible to incorporate enough air to make the product 300% of its initial volume.) The preferred method for the desired taste and texture is to use an open dasher which causes a whipping effect.

The product leaving the freezer barrel is typically between 10 degrees F. and 30 degrees F. The preferred temperature is approximately 20 degrees F. and has the consistency of soft-serve compositions.

8. Filling of Packages

From the freezer, the product is pumped to the filler, where it is deposited into a container (within the specifications set forth by national law and regulations).

9. Hardening

The filled container is then transported to a hardening room or freezing tunnel where more ice is formed in the product. The hardening room temperature should be between about −20 degrees to −40 degrees F.

10. Storage

Following hardening the product is placed in cold storage (e.g., about −5 degrees to −30 degrees F.) until it is shipped to a distributor or retailer.

Thus it can be seen that the stabilization process for combing ethyl alcohol and ice cream provides the only known process to combine ethyl alcohol and/or ethyl alcohol laden flavoring systems with ice cream for long term storage without separation or degradation. Furthermore, the system is highly reliable, simple, straightforward and yet is an economical system that can be used by any commercial ice cream maker.

While my above-description contains many specific materials and proportions, these should not be construed as limitations on the scope of the invention, but rather as exemplification of one preferred embodiment thereof. Many other variations are possible. For example, ethyl alcohol of any derivation, such as derived from a malting process, distillation process or wine making process can be combined with ice cream through the process indicated. Liquor and/or Liqueur flavoring systems are infinite in number and depend upon which flavorings are found desirable to taste.

Some of the preferred liquor and/or liqueur flavoring systems are:

a) equal parts green creme de menthe and white creme de cacao, producing a frozen ice cream beverage known as a grasshopper, creating a frozen ethyl alcohol ice cream product containing more than ½ of 1% alcohol by volume.

b) equal parts brandy and dark creme de cacao, producing a frozen ice cream beverage known as a brandy Alexander, creating a frozen ethyl alcohol ice cream product containing more than ½ of 1% alcohol by volume.

c) equal parts creme de noyaux and white creme de cacao, producing a frozen ice cream beverage known as a pink squirrel, creating a frozen ethyl alcohol ice cream product containing more than ½ of 1% alcohol by volume.

d) equal parts of Neapolitan and white creme de cacao, producing a frozen ice cream beverage known as a golden caddy, creating a frozen ethyl alcohol ice cream product containing more than ½ of 1% alcohol by volume.

e) two parts vodka, one part triple sec, one part grenadine and one part white cream de cacao, producing a frozen ice cream beverage known as a velvet hammer, creating a frozen ethyl alcohol ice cream product containing more than ½ of 1% alcohol by volume.

f) three parts vodka, one part coffee liqueur, producing a frozen ice cream beverage known as a white Russian, creating a frozen ethyl alcohol ice cream product containing more than ½ of 1% alcohol by volume.

g) equal parts whiskey and coffee liqueur, producing a frozen ice cream beverage known as a whiskey and cream, creating a frozen ethyl alcohol ice cream product containing more than ½ of 1% alcohol by volume.

h) two parts root beer schnapps and one part Neapolitan, producing a frozen ice cream beverage known as a root beer float, creating a frozen ethyl alcohol ice cream product containing more than ½ of 1% alcohol by volume.

I) one part creme de banana and one part white cream de cacao, producing a frozen ice cream beverage known as a banshee, creating a frozen ethyl alcohol ice cream product containing more than ½ of 1% alcohol by volume.

j) two parts whiskey, four parts white creme de menthe, one part vanillin, producing a frozen ice cream beverage known as an Irish mint cream, creating a frozen ethyl alcohol ice cream product containing more than ½ of 1% alcohol by volume.

k) one part vodka, three parts peach schnapps, and eight parts peach puree, producing a frozen ice cream beverage known as a fuzzy navel, creating a frozen ethyl alcohol ice cream product containing more than ½ of 1% alcohol by volume.

l) two parts coffee liqueur, one part whiskey and eight parts chocolate syrup, producing a frozen ice cream beverage known as a mud pie, creating a frozen ethyl alcohol ice cream product containing more than ½ of 1% alcohol by volume.

m) four parts rum, four parts pineapple puree, three parts pineapple juice and one part coconut creme and one part orange juice, producing a frozen ice cream beverage known as a pina colada, creating a frozen ethyl alcohol ice cream product containing more than ½ of 1% alcohol by volume.

n) one part white creme de menthe, one part dark creme de cacao, and two parts chocolate syrup, producing a frozen ice cream beverage known as a chocolate grasshopper, creating a frozen ethyl alcohol ice cream product containing more than ½ of 1% alcohol by volume.

Furthermore, any edible flavoring system that pleases or displeases the palate can be combined with alcohol of any derivation to form unique flavoring systems which, when combined with ice cream mix in this process, will create a new product, with alcohol, that can be stored long term.

The target fat ranges of the final product can be obtained through utilization of a variety of milk fat containing products. Whey and other diary product sources of solids could be substituted for milk solids. Further, this process could be used to produce other frozen or semi-soft dairy and non-dairy dessert products.

Accordingly, the scope of the invention should be determined not by the embodiment(s) illustrated, but by the appended claims and their legal equivalents.

I claim:

1. A stabilizing ice cream mix blend comprising dairy product solids, thermoreversible gum, natural or synthetic digestible gum, and a gum which contributes to the formation of a thermoreversible gel whereby said stabilizing ice cream mix blend, when combined prior to a freezing process with both
a) an ice cream mix formulation, and
b) subsequently with ethyl alcohol,
stabilizes the ethyl alcohol in a stable ice cream type product.

2. The stabilizing ice cream mix blend of claim 1 wherein said thermoreversible gum comprises carrageenan and said gum which contributes to the formation of a thermoreversible gel comprises xanthan gum, gellan gums, and mannan gums.

3. The stabilizing ice cream mix blend of claim 2 wherein said mannan gum is selected from the group consisting of locust bean gum, guar, konjac gum, tara gum and cassia gum.

4. The stabilizing ice cream mix blend of claim 1 wherein said natural or synthetic digestible gum comprises cellulosic resin.

5. The stabilizing ice cream mix blend of claim 1 wherein said natural or synthetic digestible gum comprises a material selected from the group consisting of liquid carbohydrates, glycerin, alkylene glycols, sorbitol, sorbitol solution, maltitol, lactitol, xylitol, corn syrup solids, and polyols.

6. A method for stabilizing an ice cream mix blend comprising adding a stabilized ice cream blend comprising:
a) dairy product solids,
b) a gum which contributes to the formation of a thermoreversible gel, and
c) natural or synthetic digestible gum
to an ice cream mix, forming a stabilizing ice cream mix comprising said stabilized ice cream blend and said ice cream mix, then adding a flavoring composition comprising ethyl alcohol to said stabilizing ice cream mix to form a pre-ice cream composition, then freezing the pre-ice cream composition.

7. The method of claim 6 wherein the ethyl alcohol is stabilized in a homogeneous frozen ice cream type mass by said stabilized ice cream blend.

8. The method of claim 6 wherein said thermoreversible gum comprises carrageenan and said gum which contributes to the formation of a thermoreversible gel comprises xanthan gum, gellan gums, and mannan gums.

9. The method of claim 6 wherein said mannan gum is selected from the group consisting of locust bean gum, konjac gum, tara gum, guar and cassia gum.

10. The method of claim 6 wherein said natural or synthetic digestible gum comprises cellulosic resin.

11. The method of claim 6 wherein said natural or synthetic digestible gum comprises a material selected from the group consisting of liquid carbohydrates, glycerin, alkylene glycols, sorbitol, sorbitol solution, maltitol, lactitol, xylitol, corn syrup solids, and polyols.

12. The method of claim 7 wherein said thermoreversible gum comprises carrageenan and said gum which contributes to the formation of a thermoreversible gel comprises xanthan gum, gellan gums, and mannan gums.

13. The method of claim 7 wherein said mannan gum is selected from the group consisting of locust bean gum, konjac gum, tara gum and cassia gum.

14. The method of claim 7 wherein said natural or synthetic digestible gum comprises cellulosic resin.

15. The method of claim 7 wherein said natural or synthetic digestible gum comprises a material selected from the group consisting of liquid carbohydrates, glycerin, alkylene glycols, sorbitol, sorbitol solution, maltitol, lactitol, xylitol, corn syrup solids, and polyols.

16. The stabilizing ice cream mix blend of claim 2 wherein said basic stabilizing ice cream mix is pasteurized.

17. The stabilizing ice cream mix blend of claim 3 wherein said basic stabilizing ice cream mix is homogenized, before or after pasteurization.

18. The stabilizing ice cream mix blend of claim 4 wherein said homogenized basic stabilizing ice cream mixture is cooled to less than 40 degrees Fahrenheit and above freezing and stored for one to several days to allow milk protein hydration.

19. The stabilizing ice cream mix blend of claim 5 wherein ethyl alcohol flavoring systems which have been chilled are admixed and blended into said stabilizing ice cream mix.

20. The stabilizing ice cream mix blend of claim 2, further including the addition of alcohol flavoring systems, which have been chilled to below 40 degrees F., to the stabilizing ice cream mix prior to the freezing process.

21. The stabilizing ice cream mix blend of claim 2, wherein the stabilizing ice cream mix comprises high solids content comprising milk solids and/or whey solids.

22. A method of forming a basic stabilizing ice cream mix in preparation for the admixture therewith of an ethyl alcohol and subsequent freezing of said basic stabilizing ice cream mix and the admixture of flavored alcohol, comprising the steps of:
(a) preparing a stabilizer blend mix comprised of:
I dairy product solids in the form of milk solids and whey solids equal to about 5-20% of the stabilizer blend mix by weight
ii thermoreversible gum equal to about 20-60% of the stabilizer blend mix by weight
iii cellulose gum equal to about 20-60% of the stabilizer blend mix by weight and
iv a gum which contributes to the formation of a thermoreversible gel equal to about 5-20% of the stabilizer blend mix by weight
b) preparing a basic stabilizing ice cream mix comprising of
I 2-5% fat content milk which is about 35 to 55% of the basic stabilizing ice cream mix by weight
ii 25-50% fat content cream which is about 25-45% of the basic stabilizing cream mix by weight
iii non fat dry milk which is about 2-6% of the basic stabilizing ice cream mix by weight
iv granulated sugar which is about 5-20% of the basic stabilizing ice cream mix by weight
v flavoring as about 0 to 5% of the basic stabilizing ice cream mix by weight
vi stabilizer blend mix which is about 0.05% to 2.5% of the basic stabilizing ice cream mix by weight
c) pasteurizing the basic stabilizing ice cream mix
d) homogenizing the pasteurized basic stabilizing ice cream mix before or after pasteurization
e) then cooling the basic stabilizing ice cream mix to less than 40 degrees Fahrenheit and storing it for at least two hours
f) then after storage, adding ethyl alcohol flavoring systems to said basic stabilizing ice cream mix to create a final stabilized ethyl alcohol ice cream mix
g) then freezing the final stabilized ethyl alcohol ice cream mix.

23. A method of forming a basic stabilizing ice cream mix in preparation for the admixture therewith of an ethyl alcohol and subsequent freezing of said basic stabilizing ice cream mix and the admixture of flavored alcohol, comprising the steps of:
(a) preparing a stabilizer blend mix comprised of:
I dairy product solids in the form of milk solids and whey solids equal to about 5-20% of the stabilizer blend mix by weight
ii thermoreversible gum equal to about 20-60% of the stabilizer blend mix by weight
iii cellulose gum equal to about 20-60% of the stabilizer blend mix by weight and
iv gum which contributes to the formation of a thermoreversible gel equal to about 5-20% of the stabilizer blend mix by weight
b) preparing a basic stabilizing ice cream mix comprising
I) 3-4% fat content milk which is about 40-50% of the basic stabilizing ice cream mix by weight
ii) 35-45% fat content cream which is about 30-40% of the basic stabilizing cream mix by weight
iii) non fat dry milk which is about 3-4% of the basic stabilizing ice cream mix by weight
iv) granulated sugar which is about 12-18% of the basic stabilizing ice cream mix by weight
v) flavoring which is about 0.05 to 3% of the basic stabilizing ice cream mix by weight
vi) stabilizer blend mix which is about 0.05% to 1.5% of the basic stabilizing ice cream mix by weight
c) pasteurizing the basic stabilizing ice cream mix
d) homogenizing the pasteurized basic stabilizing ice cream mix before or after pasteurization
e) then cooling the basic stabilizing ice cream mix to less than 40 degrees Fahrenheit and storing it for twelve hours to four days during which milk protein hydration occurs
f) then after storage, adding chilled ethyl alcohol flavoring systems to said basic stabilizing ice cream mix to create a final stabilized ethyl alcohol ice cream mix, and
g) then freezing the final stabilized ethyl alcohol ice cream mix.

24. The method of claim 23 creating a frozen ethyl alcohol ice cream product containing more than ½ of 1% alcohol by volume wherein the ethyl alcohol flavoring system is selected from the group consisting of
a) approximately equal parts green creme de menthe and white creme de cacao, producing a frozen ice cream beverage known as a grasshopper,
b) approximately equal parts brandy and dark creme de cacao, producing a frozen ice cream beverage known as a brandy Alexander,
c) approximately equal parts creme de noyaux and white creme de cacao, producing a frozen ice cream beverage known as a pink squirrel;
d) equal parts of Neapolitan and white creme de cacao, producing a frozen ice cream beverage known as a golden caddy;
e) approximately two parts vodka, one part triple sec, one part grenadine and one part white cream de cacao, producing a frozen ice cream beverage known as a velvet hammer;
f) approximately three parts vodka and one part coffee liqueur, producing a frozen ice cream beverage known as a white Russian;
g) approximately equal parts whiskey and coffee liqueur, producing a frozen ice cream beverage known as a whiskey and cream;
h) approximately two parts root beer schnapps and one part Neapolitan, producing a frozen ice cream beverage known as a root beer float;
I) approximately one part creme de banana and one part white cream de cacao, producing a frozen ice cream beverage known as a banshee;
j) approximately two parts whiskey, four parts white creme de menthe, one part vanillin, producing a frozen ice cream beverage known as a Irish mint cream;
k) approximately one part vodka, three parts peach schnapps, and eight parts peach puree, producing a frozen ice cream beverage known as a fuzzy navel;
l) approximately two parts coffee liqueur, one part whiskey and eight parts chocolate syrup, producing a frozen ice cream beverage known as a mud pie;
m) approximately four parts rum, four parts pineapple puree, three parts pineapple juice and one part coconut creme and one part orange juice, producing a frozen ice cream beverage known as a pina colada; and
n) approximately one part white creme de menthe, one part dark creme de cacao, and two parts chocolate syrup, producing a frozen ice cream beverage known as a chocolate grasshopper.

25. The method of claim 22 wherein said thermoreversible gum comprises carrageenan and said gum which contributes to the formation of a thermoreversible gel comprises xanthan gum, gellan gums, and mannan gums.

26. The method of claim 22 wherein said mannan gum is selected from the group consisting of locust bean gum, konjac gum, tara gum and cassia gum.

27. The method of claim 22 wherein said natural or synthetic digestible gum comprises cellulosic resin.

28. The method of claim 22 wherein said natural or synthetic digestible gum comprises a material selected from the group consisting of liquid carbohydrates, glycerin, alkylene glycols, sorbitol, sorbitol solution, maltitol, lactitol, xylitol, corn syrup solids, and polyols.

29. A stable alcohol-ice cream product comprising dairy product solids, alcohol flavoring, thermoreversible gum, natural or synthetic ingestible gum, and a gum which contributes to the formation of a thermoreversible gel, whereby said product does not separate during refrigeration at 20 to 30 degrees Fahrenheit for one week.

30. The stable alcohol-ice cream of claim 29 wherein said thermoreversible gum comprises carrageenan and said gum which contributes to the formation of a thermoreversible gel comprises xanthan gum, gellan gums, and mannan gums.

31. The stable alcohol-ice cream of claim 30 wherein said mannan gum is selected from the group consisting of locust bean gum, konjac gum, guar, tara gum and cassia gum.

32. The stable alcohol-ice cream of claim 29 wherein said natural or synthetic ingestible gum comprises cellulosic resin.
